(19) United States
(12) Patent Application Publication
(10) Pub. No.: US 2006/0152915 A1
(43) Pub. Date: Jul. 13, 2006

(54) Pool light

(76) Inventors: Robert M. Currie, Dollard-Des-Ormeaux (CA); Jonas Robertson, Harvey, IL (US)

Correspondence Address: Merek, Blackmon & Voorhees, LLC, 673 S. Washington St., Alexandria, VA, 22314, US

(21) Appl. No.: 10/857,969

(22) Filed: Jun. 2, 2004

Related U.S. Application Data
(60) Provisional application No. 60/474,626, filed on Jun. 2, 2003.

(51) Int. Cl. F21V 33/00

(52) U.S. Cl. 362/96

(57) ABSTRACT

A light having extremely low power consumption/potential that is usable in an aquatic environment. A pool light includes light emitting diodes having a very low power consumption and operatable by a non-threatening power sources such as a rechargeable battery. The pool light may incorporate a solar panel into a LED powered pool light, to create a sealed system can be created that is highly decorative and versatile, yet safe and low maintenance.

### CROSS REFERENCE TO RELATED APPLICATIONS

This application claims the benefit of U.S. Provisional Application 60/474,626 filed Jun. 2, 2003, which is hereby incorporated by reference.

### BACKGROUND OF THE INVENTION

A. Field of the Invention

The present invention relates to a sealed pool light incorporating light emitting diodes.

B. Description of the Prior Art

While it is desirable to incorporate lighting into an pool, hot tub or similar environment, water and electrical components don't mix well. It is therefore desirable to have a light with extremely low power consumption/potential that is usable in an aquatic environment. Light emitting diodes have a very low power consumption and thus can be operated by very non-threatening power sources such as a rechargeable battery. Additionally by incorporating a solar panel into a LED powered pool light, a sealed system can be created that is highly decorative and versatile, yet safe and low maintenance.

None of the above inventions and patents, taken either singly or in combination, is seen to describe the instant invention as claimed.

### SUMMARY OF THE INVENTION

The present invention is accomplished by sealing a number of light emitting diodes (LEDs), a rechargeable power storage medium, and a renewable power source in a single body to create a water-friendly light source.

Accordingly, it is a principal object of the invention to provide a pool light capable of being submerged in a pool.

It is another object of the invention to provide a submergible light that has a rechargeable power storage medium such as a rechargeable battery.

It is a further object of the invention to provide a submergible light that has a renewable power source such as a solar cell to recharge a battery.

Still another object of the invention is to provide a control unit for selectively illuminating a number of LEDs in a submergible light, that is capable of selective flashing, strobing, or changing the colors of the light as well as turning the LEDs on and off.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is perspective view of a pool light according to a first embodiment of the invention.

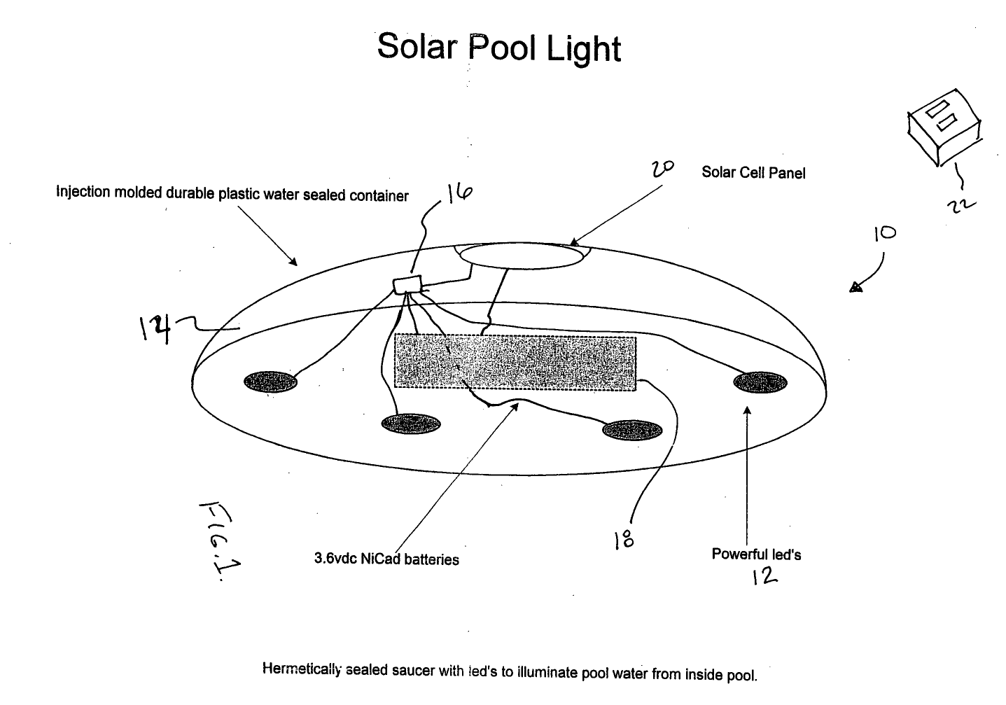

Similar reference characters denote corresponding features consistently throughout the attached drawings.

### DETAILED DESCRIPTION OF THE PREFERRED EMBODIMENT(s)

The instant invention is to a pool light 10 or the like comprised of solid-state illumination sources, i.e. light emitting diodes (“LEDs”) 12, located within a clear, translucent, opaque, or color-tinted optical conductor 14. The light source would be activated, or switched on and off, by the operation of a photocell-controlled switch, sound activated switch, or pressure switch 16 located within the optical conductor 14, proximate the LED light sources 12.

The LED light source(s) 12 could be single colored or selectively switchable between a number of colors by manual selection or automatic programming. The light emitting diodes could be constantly illuminated, automatically flashing or pulsing, blooming, changing colors, or operated by a computer type program. The operating mode of the programmed operation of the multi-colored LEDs in the pool light could be controlled by light pulses aimed at the photo-cell in the pool light from a hand held controller 22.

Operation of the LED light sources 12 would illuminate the optically conductive pool light body 16 thus lighting the pool sides and bottom, and any object in the pool water. Also located within the pool light proximate the LEDs and electrical switching means would be a rechargeable battery 18 or other type of electrical power storage device such as a capacitor, of a voltage and power rating sufficient to operate the LEDs or other light sources. The battery could be charged through a solar cell 20 The power storage capacity should be sufficient to operate the LED light sources for a minimum of several hours.

Various colors of light emitting diodes could be used to illuminate the pool light. The combination of LEDs, electrical switching means, power storage device, and electrical storage charging means, could be located within a small decorative package (not shown) that would be visible inside of the light transmissive pool light.

The LEDs would be visible through the side of the package and illuminate the pool area through the body of the light transmissive pool light. The pool light would preferably be heavy/dense enough to sink to the bottom of a pool or other body of water. The pool light decorative package would be molded, encapsulated, or otherwise sealed within a light transmissive, optically conductive shape, preferably round or oval on the top and flat on the bottom.

It is to be understood that the present invention is not limited to the sole embodiment described above, but encompasses any and all embodiments within the scope of the following claims.

I claim:

1) A portable pool light designed to sink to the bottom of a pool and light said pool with a variety of colors and patterns.

2) The pool light of claim 1 wherein all electrical components of said pool light are sealed within a water tight, heavier than water optically transmissive shape.

3) The pool light of claim 1, further comprising solid state light sources.

4) The pool light of claim 1, further comprising light emitting diodes.

5) The pool light of claim 4, further comprising a control means for selectively illuminating said light emitting diodes, wherein the control means is selected from one of photo sensitive switching, sound sensitive switching, or pressure sensitive switching.

6) The pool light of claim 5, further comprising a control means for selectively illuminating said light emitting diodes, wherein said control means includes means to flash or pulse on and off, change colors, bloom, strobe, or to program said light emitting diodes.

7) The pool light of claim 6, wherein said control means may be activated by light pulses from a hand held controller to a photo cell within said pool light.

8) The pool light of claim 1, wherein said pool light includes a pool light body made of clear, translucent, or color tinted optically transmissive material.
